(19) United States
(12) Patent Application Publication
(10) Pub. No.: US 2006/0149673 A1
(43) Pub. Date: Jul. 6, 2006

(54) Secure internet transaction system

(76) Inventor: Patrick Y. Delefevre, Watertown, MA (US)

Correspondence Address: Robert K. Tendler, 65 Atlantic Avenue, Boston, MA, 02110, US

(21) Appl. No.: 11/137,299

(22) Filed: May 25, 2005

Related U.S. Application Data
(60) Provisional application No. 60/641,065, filed on Jan. 3, 2005.

(51) Int. Cl. H04L 9/00

(52) U.S. Cl. 705/44

(57) ABSTRACT

A secure Internet authorization system is based on matching of randomly generated number strings, generated at a module carried by an individual seeking authorization and uploaded to an offline vault during a setup procedure. During authorization the module generates one portion of the string, with the vault generating a quickly disappearing second portion of the string. Upon arrival of both portions at an Authorization Requesting Protocol and match at the vault the action to be authorized is authorized.

### RELATED APPLICATIONS

This Application claims rights under 35 USC §119(e) from U.S. Application Ser. No. 60/641,065 filed Jan. 3, 2005, entitled “Internet Security System,” the contents of which are incorporated herein by reference.

### FIELD OF THE INVENTION

This invention relates to security systems that use the Internet for transactions and more particularly to a system in which authorization for a transaction requires a randomly generated number, one part of which is deleted at the instant of authorization.

### BACKGROUND OF THE INVENTION

Internet security, especially as it relates to Internet transactions, has been problematical due to the fact that passwords, user names and other coding data is available on the Internet for hackers to see from which they can generate authorization codes for obtaining vital information. If the transaction is, for instance, buying a product over the Internet using one's credit card results in sensitive information on the Internet that can result in identity theft and its consequences.

Various coding schemes have been proposed that are meant to make the Internet more secure as a commercial vehicle, with the coding schemes requiring more and more bits of security-coded information, the number of bits of information presumably making the transaction more secure. Moreover, key words known only to the user, such as the user's mother's maiden name, may be elected to authorize a transaction.

However, recently, even when using randomly generated numbers, if these numbers are transmitted over the Internet, techniques have been developed to analyze the randomly-coded numbers and to be able to duplicate the authorization code. It has been demonstrated that it is only a matter of time before any randomly-coded number can be decoded.

This being the case, various levels of security have been proposed, including the so-called Secure Socket Layer system that has been used to improve the security of banking transactions over the Internet.

However, due to the new algorithms that are capable of deciphering randomly-coded numbers that are used in such transactions, it is possible for a hacker to invade the banking institution and to alter records or retrieve funds held by the banking institution.

There is therefore a necessity to provide a totally new security system for Internet transactions for which the probability that a hacker can obtain information over the Internet is minimized to the point of being almost certainly unlikely to occur.

### SUMMARY OF INVENTION

Rather than using traditional techniques for authorizing transactions involving passwords and user ID that are viewable on the Internet, in the subject invention Internet-based transactions are authorized in a way that the authorizing information is never available on the Internet at the same time and in which a portion of the authorizing information is automatically self-deleting just after it is created. Moreover, a user's device randomly generates as many as one million number strings that are used one each per transaction and never used again. These authorizing number strings are set up to be divided into two parts: first, a Secret Number, which is generated at and carried by the user's module or device; and a Missing Link Key portion of the number, which is stored in a vault offline. The Secret Number and the Missing Link Key are required to be available at the same time to create an authorization. The reason for dividing up the number string into two parts is to prevent an unauthorized entity to present himself as the true authorization entity, since each of the two parts of the number must be separately activated to achieve authorization.

To add to the security, during a setup operation the user physically takes his module to the vault, where the randomly generated number strings are uploaded to the user's vault lock box, with this transaction being done offline and not visible on the Internet.

When the user desires to authorize a transaction, a purposely-complex set of authorizing steps is involved between the user's module or device, the vault, and an authorizing entity called an Authorization Requesting Protocol or ARP. This complex set of authorizing communications is to make sure that the user's module, vault and ARP are correctly connected.

Once having established that the appropriate entities are connected, the randomly generated Secret Number portion of the string is transmitted from the user's module or device over the Internet to the ARP which has been previously provided with the Missing Link Key that, once created, dies. The coincidence of the Missing Link Key and the Secret Number at the ARP results in the two sections of the randomly generated number string being encrypted and sent to the vault, which then provides an authorization signal back to the ARP. The vault only sends the authorizing signal when the two sections of the number string match the user's number string as stored in his vault lock box.

From the Internet security point of view, the Missing Link Key is never available on the Internet simultaneously with the Secret Number portion of the randomly generated number string. Moreover, since the Missing Link Key is born to immediately die, it does not exist on the Internet but for a fleeting moment. Even if the Missing Link Key were viewed on the Internet, it would be useless because the Missing Link Key, if used for another transaction, would fail.

Thus the subject Internet security system includes a complex set of authorization protocols just to assure that all entities are properly connected, followed by an authorization protocol that requires two parts of a randomly generated number string to be available at the ARP and for the combined encrypted number string to match the completed number string that has previously been stored in the user's vault lock box.

Note that the number strings are randomly generated by the user's module or device at the time he physically couples his module or device to the vault for uploading his particular series of randomly generated number strings, each divided out into a Secret Number portion and a Missing Link Key portion. The stored vault lock box contents are never viewable in their entirety on the Internet, with the only piece of lock box data momentarily viewable being the self-destructing Missing Link Key.

Thus, rather than using the traditional techniques, in the subject invention a chip within a module is used to generate millions of randomly generated number strings. These randomly generated number strings are divided into two segments. The first segment, called the Secret Number X portion of the number, is divided from the Y segment, the Missing Link segment or key. It is a feature of the subject invention that whenever used, the Missing Link portion is “born to die,” meaning that it is automatically deleted after it has been released, in this case the authorization requesting protocol or ARP, which serves as the authorizing clearing house to provide an authorization signal to, for instance, a financial institution. Note the authorizing entity can be a clearing house or any entity that requires authorization.

In order to establish the security of the subject system, the module is physically coupled to a vault outside the Internet cyberspace. The module can generate all of the millions of randomly generated number strings, which are physically uploaded to storage at the vault. These strings include both the first section of the number, the Secret Number X section, and the Y portion of the number, the Missing Link section. The result is the storage of the segmented randomly generated number strings in the user's lock box within the vault. Note that the module or device keeps only the Secret Numbers once it has randomly generated the number strip.

In order to obtain authorization for a transaction, the user takes his module to a terminal, an on-line computer, or a wireless device at which the transaction is to be made. Each module possesses a unique user name and password. The user name and password, upon a request for authorization, is transmitted to the vault that starts an activation process to make sure that the user's module, the ARP and the vault are correctly connected. Upon receipt of the correct user name and password, the vault issues an activation code to the module. The module then transmits the fact that it is activated to the ARP such that the ARP is activated by an activated module or device. Thereafter, the ARP sends a signal to the vault so that the vault is activated by the activated ARP to send the Missing Link portion of the random number string to the ARP. After the Missing Link key is supplied to the ARP, it is automatically deleted. The user then sends the Secret Number X portion of the string to the ARP, which now has in its possession the Missing Link portion or key of the number string, upon which two numbers are transmitted from the ARP back to the vault. The vault then matches both the secret X number and the Missing Link Y portion or key to issue an authorization signal to the ARP. The ARP then sends the authorization to the terminal or other device at which the person is making the purchase or authorizing his identity, thus to authorize the transaction.

As a further level of security, the randomly generated number strings that are initially uploaded into the vault are set up in groups. Thus, in one embodiment, in order to obtain authorization, the ARP device will be only supplied with the secret random number if the particular group is known. The particular group is also secret and is uploaded to the ARP at the same time that the Missing Link key is uploaded to the ARP, namely when the vault sends its information to the ARP.

If there is no group number transmitted to the user's module, then the secret random X number is never supplied to the ARP. This adds an additional level of security, namely the fact that not only must the Missing Link key portion, the Y portion of the random number string, be available to the ARP, but also the group number must also be supplied to the ARP.

As will be appreciated, in this process the Missing Link key is automatically deleted when generated. This means that it is only available momentarily on the Internet, making it virtually impossible to discover. Note that the Missing Link key is never sent to the ARP at the same time as the Secret Number. Thus the likelihood of detection of the entire randomly generated string by viewing the Internet is nil.

Moreover, none of the above can occur unless one physically accesses the vault, which can be guarded. The vault is the only place where the two sections of the randomly generated string is stored. The random strings are unique to a given module and the module output can only be uploaded to the vault upon physical access of the module to the vault.

Moreover, each time a user seeks authorization, his module outputs a different one of the randomly generated number strings that have previously been stored in the vault. Thus no Secret Number from the module is ever used again once it is used. In one embodiment, the random number string used by a module is itself randomly selected, thus offering another level of security.

In short, a set of randomly generated number strings from the user's module or device are initially uploaded to the vault where they are categorized by group in one embodiment and are separated out into the Secret Number and a Missing Link or key portion. During runtime, the vault is accessed with user names and passwords, which are used to activate the user's module or device, the ARP device and also to activate the vault by the activated ARP to send both the Missing Link key and in one embodiment the Group Number to the ARP. It is a feature of the subject invention that while the Internet may be used both to have the vault communicating with the ARP and the user device or module connected to the ARP, the number string corresponding to the Missing Link Key is only available momentarily over the Internet, after which time it is automatically deleted. Thus, a hacker connected to the Internet will be able to assemble the original random number string only momentarily because the Missing Link Key vanishes after it has been generated and sent to the ARP. In one embodiment, the Missing Link Key only exists on the Internet for the length of time it takes to transmit it. Even for exceptionally long Missing Link Keys, it will exist in cyberspace only for less than a microsecond. Thus, in order to be able to decode the original random number string, one must have simultaneously available on the Internet the secret first portion of the randomly generated number string plus the Missing Link key portion. Since these are not generated at the same time, it is virtually impossible to re-create the original randomly generated number string. This is because the sections do not exist on the Internet at the same time and also because at least one section of the number is automatically deleted after creation. Also, the randomly generated number string is only used once, after which it cannot be re-accessed.

Thus, the Missing Link key is born for only one transaction and then dies. These Missing Link keys cannot be read over the Internet because they are programmed to be accessed over the Internet only one transaction at a time. The other Missing Link Keys are kept in the user's lock box in the vault for other transactions.

In summary, secure Internet authorization system is based on matching of randomly generated number strings, generated at a module carried by an individual seeking authorization and uploaded to an offline vault during a setup procedure. During authorization the module generates one portion of the string, with the vault generating a quickly disappearing second portion of the string. Upon arrival of both portions at an Authorization Requesting Protocol and match at the vault the action to be authorized is authorized.

### BRIEF DESCRIPTION OF THE DRAWINGS

These and other features of the subject invention will be better understood in connection with a Detailed Description, in conjunction with the Drawings, of which:

FIG. 1 is a diagrammatic illustration of the setup of the subject invention in which a set of randomly generated number strings are uploaded to a vault so as to be able to be segmented into a Secret Number portion and a Missing Link Key portion;

FIG. 2 is a table illustrating the randomly generated number strings by the module in FIG. 1 being separated into a Secret Number portion and a Missing Link Key portion, which are uploaded to a vault and stored in the same form, after which only the Secret Number portions remain in the module;

FIG. 3 is a diagrammatic illustration of a runtime version of the subject system in which a user enters a user name and password coupled to the vault, which in turn activates the user device to transmit the Secret Number portion and transmits a Missing Link Key portion, which dies, with both numbers being input to an authorization requesting party, with the result being the entire randomly generated string uploaded to the vault for a matching authorization function;

FIG. 4 is a diagrammatic illustration of the system of FIG. 3, illustrating the various steps involved in obtaining authorization;

FIG. 5 is a flow chart illustrating the authorization steps in order for the subject system to provide authorization for a given transaction;

FIG. 6 is a flow chart illustrating the setup of the vault to input various fields within the vault memory to recognize user names and passwords to generate activations and to store various randomly generated number strings, including groups, Secret Number portions and Missing Link Keys;

FIG. 7 is a flow chart illustrating the setup of the module corresponding to the user device to be able to perform the activations and to generate the group numbers and the Secret Numbers that are used later in the system;

FIG. 8 is a flow chart showing the setup of the user device module for installing the user name, the password, the ARP address and the group number for the secret randomly generated number, such that the module is set up for a certain user name and password and the ARP address of the ARP that will be used in authorizing the transaction;

FIG. 9 is a flow chart showing the runtime sequence for authorization by a user in which the user enters a user name and password, which is matched giving the opportunity to change the grouping number and thereafter to select a group at any given time, followed by the ability to select what section of the vault will be accessed;

FIG. 10 is a flow chart describing the authorization steps after vault section selection, which includes having the user provide the ARP address to the vault as Step 1, followed by the insertion of the user device and the ascertaining that a vault section is on-line, which is in turn followed by the vault sending an activation number 1 to the user device module for matching at Step 2, with the module then sending an activation signal through a matching process to activate the ARP as Step 3, followed by the ARP sending an activation to the vault to permit the vault to check the ARP address and activation, with a match indicating that the user has selected the appropriate ARP from which continued operation occurs;

FIG. 11 is a flow chart illustrating that after authorization the vault accesses a Missing Link Key and sends the Missing Link Key plus a group number to the ARP as Step 5, followed by the ARP sending the group number to retrieve the corresponding Secret Number in Step 6, followed by the module sending the corresponding Secret Number to the ARP as Step 7, upon which the ARP encrypts the combination of group number, Secret Number and Missing Link Key, which is transmitted to the vault in Step 8 for the ultimate authorization, with a match being transmitted from the vault as Step 9 to the ARP;

FIG. 12 is a flow chart illustrating the ability of the user to change the particular group that is accessed for authorization to further limit authorization for sensitive transactions;

FIG. 13 is a flow chart illustrating what happens when a user name or password is not matched, showing a three-trial procedure for matching; and,
FIG. 14 is a flow chart illustrating the procedures that take place when the first activation is not matched, indicating a wrong user device or module, with the vault asking the user to re-install the device for further possibility of activation.

### DETAILED DESCRIPTION

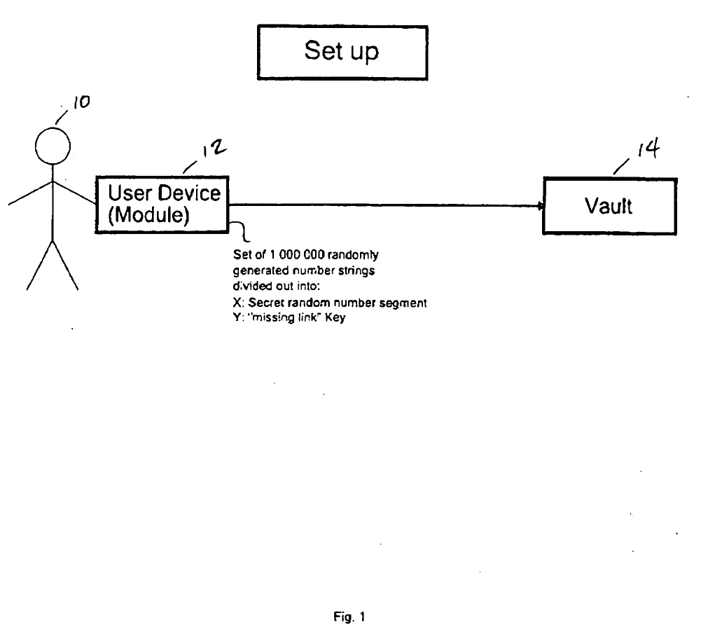

Referring now to FIG. 1, in the initial setup, an individual 10 has on his person a module or device 12, which is set up to generate a set of randomly generated number strings, which may be as many as a million such strings. The strings are set up such that the first part of the string is a secret set of numbers in the string corresponding to the first random number segment. The second portion of the string is utilized as the Missing Link Key, which is available on the Internet only momentarily and which does not simultaneously exist on the Internet with the secret random number segment. Module 12 is physically connected to a vault 14 for the uploading of the set of randomly generated number strings, divided out into the X Secret Number segment and the Y Missing Link Key segment. These number strings are stored in the vault for use in the authorization process.

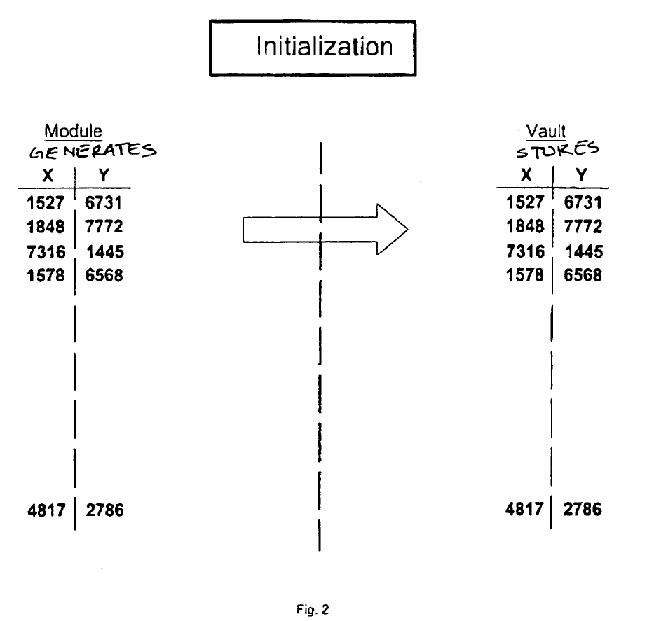

Referring to FIG. 2, what has been accomplished by the use of the module that contains its own random number-generating processor is that the module initially generates the aforementioned number strings such that, for a first number string, the Secret Number may be the digits 1, 5, 2 and 7, whereas the remainder of the string, 6, 4, 3 and 1, corresponds to the Missing Link Key. As can be seen, a number of strings are generated, which are installed verbatim in the vault such that the vault, upon physical access of the module to the input apparatus for the vault, stores identically the strings generated in the module and in the sequential order established by the module.

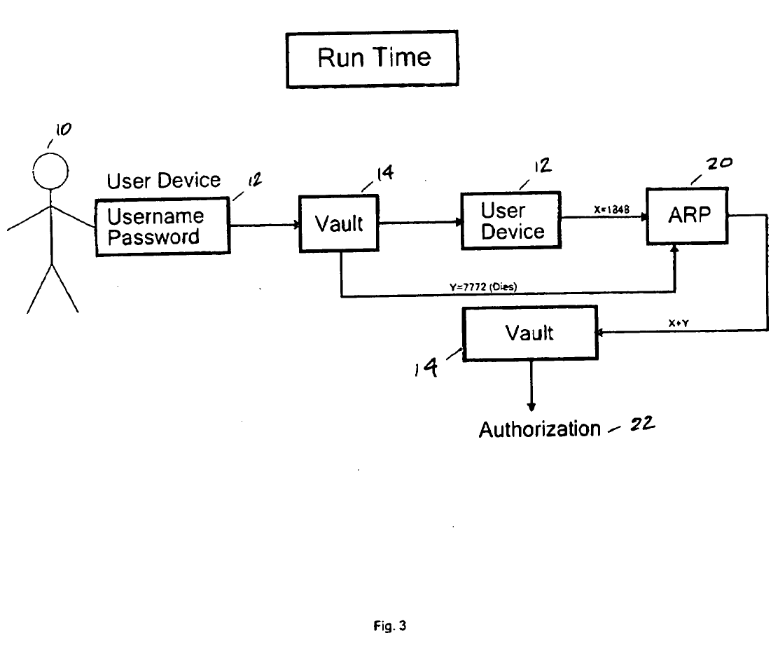

Referring to FIG. 3, in general and during runtime, when user 10 seeks authorization, module 12 generates a user name and password previously installed in the module and passes it to vault 14, which establishes a number of authorization procedures to make sure that the user device or module is connected or will be connected to a predetermined ARP, here shown by reference character 20. In so doing, after authentication to ascertain that the user is connected to the right vault, which is connected to the right ARP, the vault transmits the Missing Link Key Y to ARP 20, after which the Missing Link Key dies. After the Missing Link Key has been inputted to ARP 20, the vault authorizes the user device module 12 to output the secret, randomly generated number X, which is then uploaded to ARP 20. At this point in time, both the Secret Number, in this case 1848, and the Missing Link Key, 7772, exist at ARP 20. ARP 20 subsequently sends both X and Y, which constitutes the originally specified random number string to vault 14 for establishing a match between that number and the number strings previously stored in the vault to establish an authorization signal, here shown at 22.

It will be appreciated that the only time any one of the two segments of the randomly generated number string are available on the Internet is the extremely short period of time when the Missing Link Key is created and then deleted. It will also be noticed that the user device or module 12 transmits the Secret Number portion of the randomly generated number string at a different time than the Missing Link Key is generated. This means that that which is available over the Internet is virtually undetectable by a hacker because the hacker must be able to quickly recognize the presence of a Missing Link Key, store it and then wait until the Secret Number is transmitted. The level of security provided is such that, since the Missing Link Key is virtually undetectable and further, since it must be correlated with a later transmitted Secret Number, is virtually impossible for somebody viewing the Internet to be able to ascertain the two portions of the randomly generated number string for which the vault may be interrogated to provide an authorization indication.

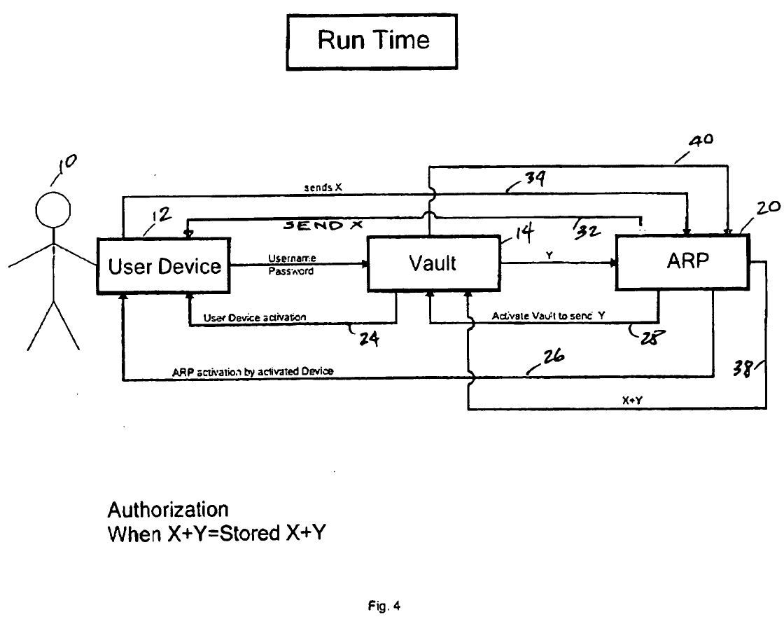

Referring now to FIG. 4 and more particularly in one embodiment of the subject invention, user 10 transmits from the user device or module 12 a coded message including the user name and password, which is uploaded to vault 14. In turn, vault 14, upon a match, generates a user device or module activation signal 24, which is passed back to the user device or module. Upon activation, the user device or module transmits an activation signal over line 26 to activate ARP 20, which functions as a second level of activation to indicate, for instance, that the proper vault has authorized the proper module to activate the proper ARP.

Upon receipt of the activation signal from the authorized module, the ARP sends a signal over line 28 to the vault to instruct vault 14 to send the Missing Link Key Y over line 30 to the ARP. Simultaneously, an instruction is sent over line 32 to instruct corridor module 12 to transmit the Secret Number X to ARP 20. Upon instruction, module 12 then transmits X, the Secret Number, over line 34 to ARP 20. At this point, ARP 20 is authorized to send both the Secret Number X and the Missing Link Key Y over line 38 to vault 14 for a matching process. If this number string, including both the Secret Number X and the Missing Link Key Y is matched in vault 14, then vault 14 sends an authorization signal over line 40 to ARP 20 to generate its own authorization signal to be used to authorize a particular transaction required by user 10.

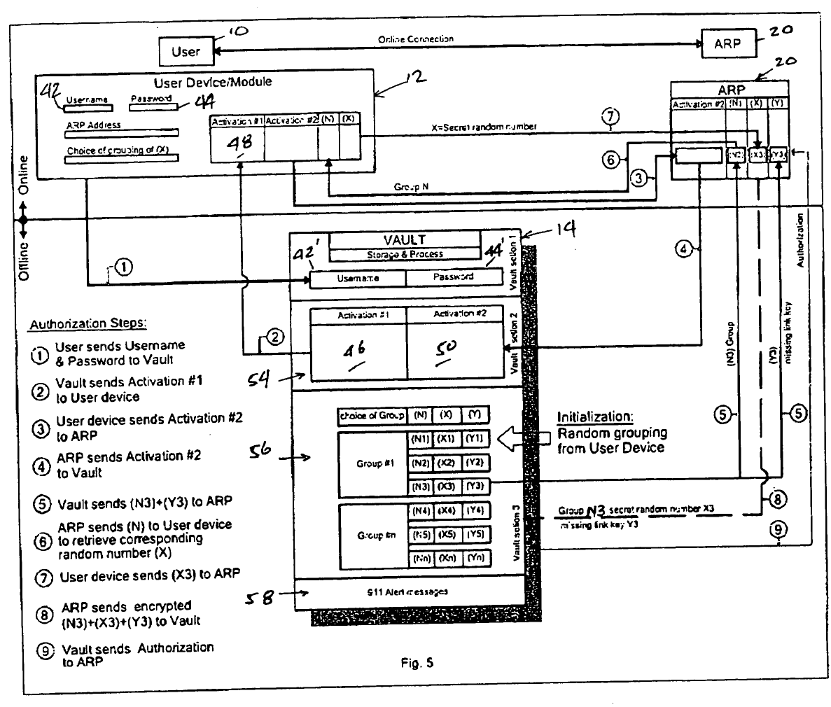

More particularly and referring now to FIG. 5, the above process is described in detail.

The first step, Step 1, requires the user to send his user name and password to the vault, with the user name being previously stored in user device or module 12 as user name 42 and password 44. These user names and passwords have previously been uploaded to vault 14 as user name 42′ and password 44′.

As Step 2, vault 14 sends activation number 1, here illustrated by reference character 46 to module or user device 12, which recognizes activation one in a storage and processing portion of module 12, as illustrated at 48.

In Step 3, the user corridor module 12 send activation number 2 to ARP 20, which activates the appropriate ARP. In so doing, ARP 20 then transmits activation 2 to vault 14, as illustrated at 50. This completes Step 4.

In Step 5, vault 14 sends the particular group number and the Missing Link Key to ARP 20, with the group number and the Missing Link Key having been previously established by module 12.

As Step 6, ARP 20 sends the group number to the user device or module 12 to retrieve the corresponding secret random number X from the module, with Step 7 referring to the transmission of the secret randomly generated number, here illustrated as X3, to ARP 20.

As Step 8, since the ARP now has in its possession N3, the particular group number involved, X3, the particular Secret Number involved, and Y3, the particular Missing Link Key involved, ARP 20 sends, in encrypted form, these numbers to vault 14, where they are matched.

Upon match, as Step 9, vault 14 transmits authorization to ARP 20 to authorize the particular transaction.

Also shown in this figure is the grouping of the various strings, with the strings having a group number n, a Secret Number Xₙ and a Missing Link Key Yₙ, each for a given group. These numbers are stored and programmed in a way that when one of them is accessed, such as Y₁, the other Missing Link Y₂ will not be available on-line for hackers to access. Thus, no other Missing Link Keys are available even if they could be viewed. Here it is illustrated that there are n groups, thereby multiplying the complexity of the access to vault 14.

Note also that the vault is arranged in three sections, namely the user name and password section 52, the activation section 54 and the main storage for the group, secret word, and Missing Link Key number strings 56. Note that section 56 is where the authorization is finally completed upon matching of the encrypted message from the ARP to the vault. Note also that, as illustrated at 58, should anything be amiss, meaning that an outside source is attempting to access the vault and its contents, not necessarily from the Internet, which is impossible, but from physical means, then 911 alert messages are transmitted to the appropriate authorities.

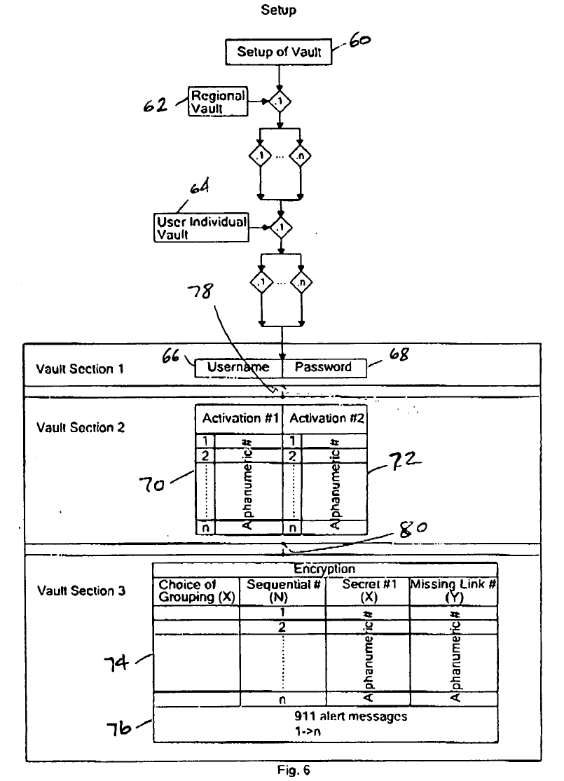

Referring now to FIG. 6 and more particularly for the setup of the vault, in Step 60 the vault is set up by first establishing what vault it is. If it is a regional vault as illustrated at 62, this is noted. The regional vault is further subdivided into the user's individual vault 64 into which is entered a user name 66 and a password 68 in Vault Section 1. Thereafter, as illustrated in Vault Section 2, an activation number 70 for Activation Number 1 is implemented as a series of alphanumeric numbers for flexibility. Note also at this time Activation Number 2 is uploaded to Vault Section 2, as illustrated at 72, again with a series of alphanumeric numbers for flexibility.

In Vault Section 3, as part of the encryption afforded by the subject system and as illustrated at 74, there is a choice of grouping for the Secret Numbers, which constitutes a sequential number N, which defines the group number. What is then uploaded is the series of Secret Number strings and simultaneously Missing Link Key strings, each associated with each other so as to populate the vault for the particular individual with his unique set of 1 million or so number strings, subdivided as mentioned before into Secret Numbers and Missing Link Keys. Also installed at this time are a number of 911 abort messages as illustrated at 76.

It will be noted that the uploading of the randomly generated number strings constitutes a key to the vault, as illustrated at 78, and another key to the vault as illustrated at 80. These are the keys that are momentarily available on the Internet.

It will be appreciated that that which is transmitted over the Internet, which accesses the vault, is available on the Internet for only a fraction of a moment. Thus the vault is opened only for a fraction of a moment to receive the encrypted, randomly generated string. It is only during this particular instant of time that the link is open from the ARP to the vault so that the vault may be accessed to ascertain if there is an authorization permitted.

Thus it can be seen that whatever connection there is between the ARP and the vault is only opened and closed for an instant in time and only with a software key, the software key being the Missing Link Key from the ARP.

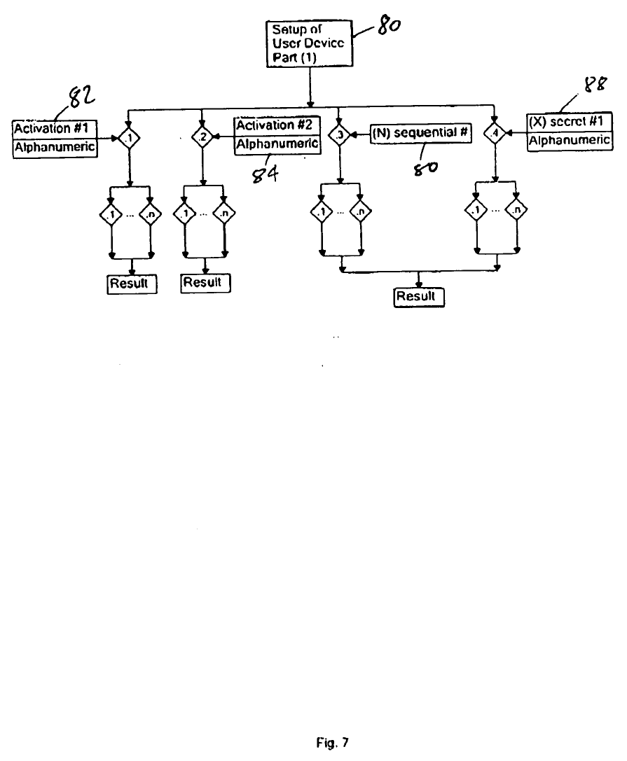

Referring now to FIG. 7, in the setup of the user device as it relates to Section 1 of the vault, as illustrated at 80, one installs the activation number 1 code, as illustrated at 82, the activation 2 code as illustrated at 84, and the sequential group number N as illustrated at 86. One also installs the secret randomly generated number X at 88. All of these codings and number strings are therefore set up in the user device or module and may be generated by a random number generator in sequence.

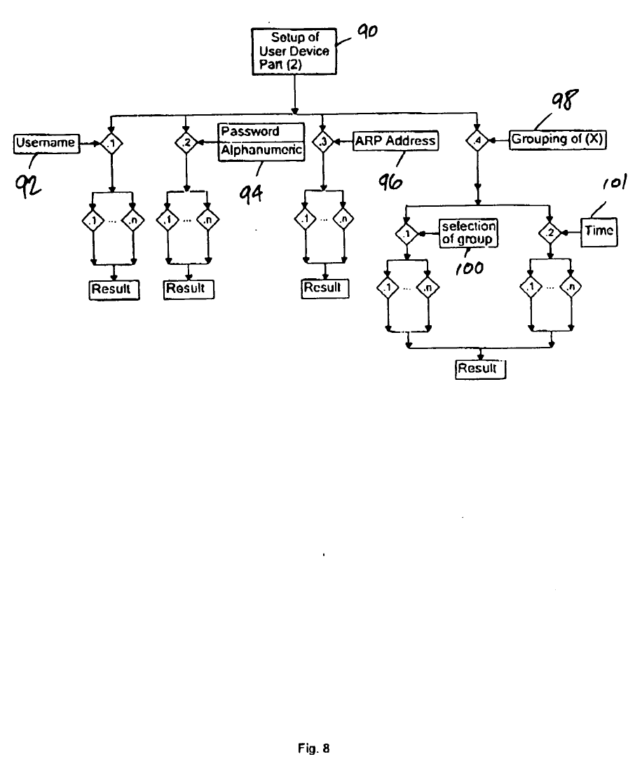

Referring now to FIG. 8, in the setup of the user data as it relates to Section 2 of the vault, as illustrated at 90, the stored user name is available as illustrated at 92, the password at 94, the selected ARP address at 96 and a particular grouping of secret, randomly generated numbers 98, with the group selection being alterable at 100 and the time being inputted at 101 such that all of the above is available at a particular time instant.

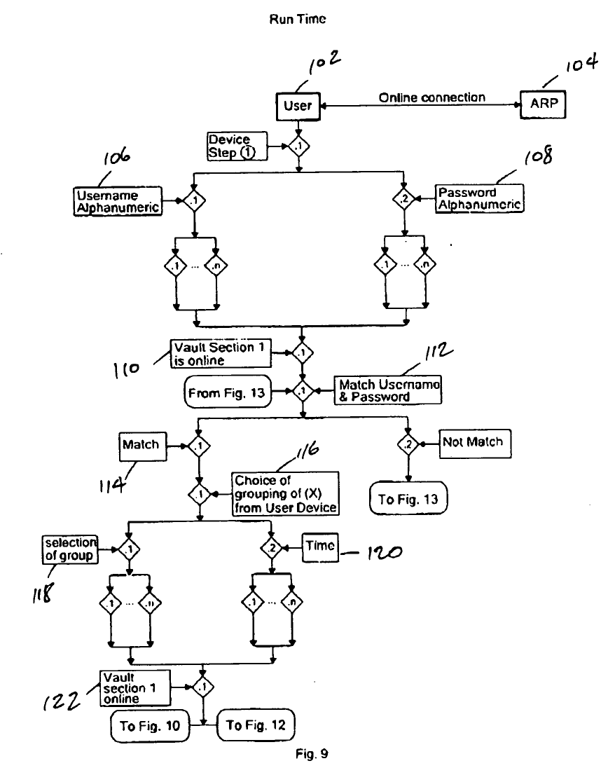

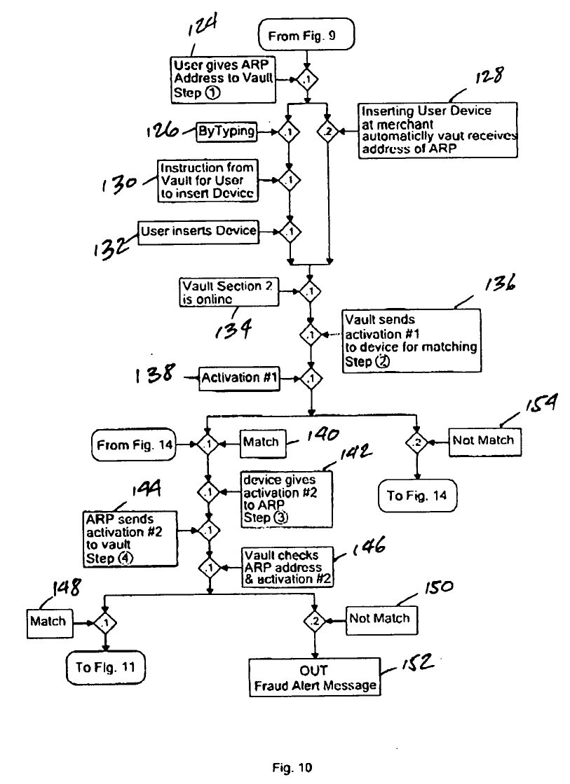

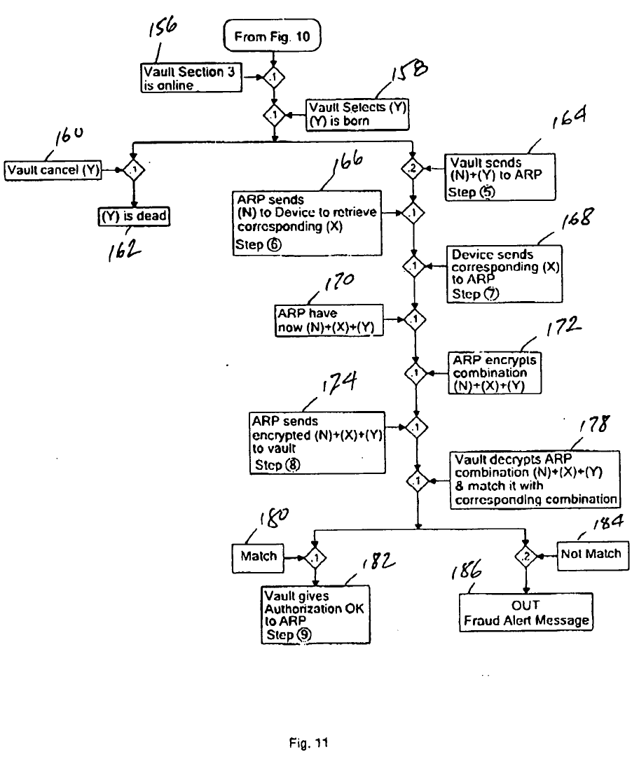

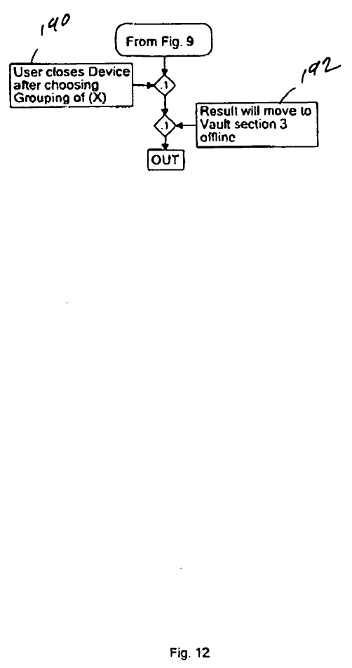

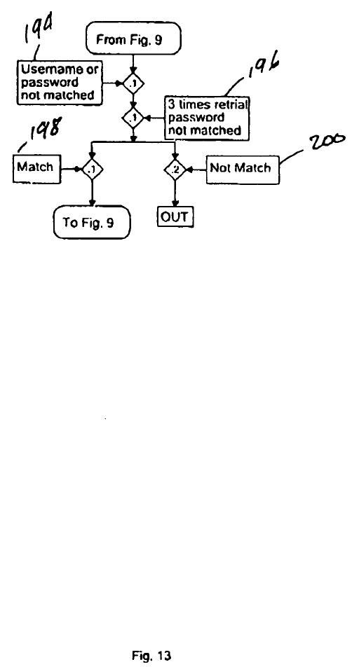

Referring now to FIG. 9, during a runtime operation, the user 102 establishes an on-line connection with ARP 104 and in Step 1 described above outputs the user's user name 106 and his password 108, which is combined through Vault Section 1, if it is on-line as illustrated at 110, to establish a match as illustrated at 112. Upon establishment of a match as illustrated at 114, and assuming a choice of grouping from module 12 as illustrated at 116, a particular group is selected as illustrated at 118 at a particular time 120 to access Vault Section 1 as illustrated at 122.

Referring now to FIG. 10, as illustrated at 124, the user gives ARP 20 the ARP's address to the vault, either by typing as illustrated at 126 or by inserting the module or user device at a merchant, as illustrated at 128. If by typing, there is an instruction from the vault for the user to insert a device and thereafter the user inserts the device as illustrated at 132 in accordance with the instruction. At this point Vault Section 2 is accessed and is on-line, as illustrated at 134. Thereafter in accordance with Step 2, the vault sends activation number 2 to module 12 for matching, as illustrated at 136. Upon activation match, as illustrated at 138, the fact of the match, as illustrated at 140, causes the module or device to generate an activation number 2 and send it to the ARP, as illustrated at 142. At this point the module or device gives the activation number 2 to the ARP in accordance with Step 3, whereas in Step 4, as illustrated at 144, the ARP sends activation number 2 to the vault. As illustrated at 146, the vault checks the ARP address and activation number 2 and if there is a match, as illustrated at 148, the process proceeds. If there is no match, as illustrated at 150, there is a fraud alert generated as illustrated at 152.

Moreover, if there is not match for activation 1, as illustrated at 154, then a routine is invoked as illustrated in FIG. 13.

Referring now to FIG. 11, assuming that Vault Section 3 is on-line, as illustrated at 156, the vault selects the Missing Link Key Y at 158, which refers to the fact that the Missing Link Key is born. Immediately thereafter, the vault cancels the Missing Link Key, as illustrated at 160, with the result being the aforementioned fact that the Missing Link Key is deleted, dead or is used only once, as illustrated at 162.

Upon generation of the Missing Link Key, the vault sends the group number and the Missing Link Key to the ARP, as illustrated at 164, in Step 5.

Step 6, as illustrated at 166, involves the ARP sending the group number to Module 12 to receive the corresponding secret, randomly generated number X. Thereafter, at Step 7 and as illustrated at 168, the module sends the corresponding Secret Number X to the ARP, whereupon the ARP, as illustrated at 170, now has in its possession the group number, the Secret Number and the Missing Link Key. As illustrated at 172, the ARP then encrypts this combination, namely N+X+Y, and as illustrated at 174, sends the encrypted N+X+Y to the vault as Step 8. This is done only momentarily over the Internet such that the vault is only open momentarily to accept the transmission from the ARP and then the connection is closed down.

The vault decrypts the ARP combination of N+X+Y, as illustrated at 178, and matches it with the corresponding number string combination. If there is a match, as illustrated at 180, the vault, as illustrated at 182, gives authorization to the ARP as Step 9.

If there is no match, as illustrated at 184, a fraud alert is illustrated at 186.

As illustrated in FIG. 12 at 190, as a further security action, the user closes the module after choosing the grouping desired for the Secret Number. The result, as illustrated at 192, is that the information is stored in Vault Section 3, at which point the vault is off-line.

Referring now to FIG. 13, a process is described in which the initially-entered user name is password is not matched. This is illustrated at 194. If the user name and password are not matched, then there is a three-time trial for matching, as illustrated at 196. If there is a match, as illustrated at 198, then one can proceed. If after three tries there is no match, as illustrated at 200, the process is terminated.

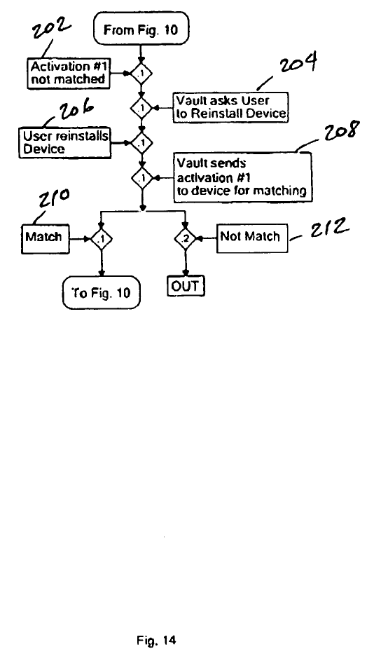

Referring now to FIG. 14, assuming that activation of module 20 is not matched as illustrated at 202, the vault asks the user to reinstall the module or device, as illustrated at 204. The user then reinstalls the device or module, as illustrated at 206, and the vault sends activation number 1 to the module or device for matching, as illustrated at 208. If there is a match, as illustrated at 210, then the process proceeds. If there is no match at this particular point in time, as illustrated at 212, the process terminates.

What will be appreciated from the above is that the vault is only momentarily connected to the Internet and only for purposes of transmitting activations, quickly-dying Missing Link Keys, Secret Numbers and then finally establishing an encrypted link from the ARP to the vault. At all other times, the vault is completely disconnected from the Internet and cannot be accessed by those seeking to access it over the Internet. Moreover, because certain number strings and coding is only available at different times over the Internet, one would have to correlate all of these fleetingly available pieces of information in order to establish an authorization. The result is that Internet transactions are made exceedingly more secure than heretofore possible due to the fact that there must be a physical interaction between the user and his module and input apparatus to the vault. Moreover, randomly generated numbers are only used once by the system and, more importantly, the Missing Link Key is first created and then uncreated or removed in an instant, where it is no longer accessible by anybody over the Internet. Even if the Missing Link Key is viewed at the exact fraction of a second that it is generated, then if it is used for another transaction it will fail.

Finally, the matching that is done in the subject system is done in such a way that each individual has his own secure vault, with its own sequence of randomly generated number strings in which for each transaction are only accessed once. No longer are passwords and user names and other encoding data created for any length of time and visible on the Internet. Aside from a physical robbery at gunpoint or otherwise to the vault, the vault is as secure as any other bank vault. Thus the fear of using the Internet for whatever transactions are desired is dramatically reduced and even eliminated, since the transactions require the physical presence of the individual and his module, both to create his own individual vault and also to access his own individual vault. Moreover, safeguards are in place to make sure that the individual's module, the authorized ARP and his own vault are in communication at the time of the transaction. Note that it is the responsibility of the user to safeguard his device. If, however, the device is lost, the subject system is provided with the ability to erase all of the data on the user's lock box at the vault.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. A method for providing a secure transaction using the Internet, comprising the steps of:
at a module, randomly generating a large number of number strings, each number string characterized by a Secret Number portion and a Missing Link Key portion;
physically uploading the randomly generated number strings into a vault that is off-line;
transmitting a request for authorization of a transaction to the vault over the Internet to invoke an Authorization Requesting Protocol for authorizing the transaction;
upon initial validation of the authorization request by the vault, transmitting the Missing Link Key portion of the corresponding randomly generated number string stored in the vault to the Authorization Requesting Protocol;
automatically deleting the transmitted Missing Link Key portion immediately after transmission;
transmitting from the module the Secret Number portion of the randomly generated number string to the Authorization Requesting Protocol;
transmitting from the Authorization Requesting Protocol to the vault an encrypted number corresponding to the randomly generated number string, including the Secret Number portion and the Missing Link Key portion;
decrypting the encrypted number string at the vault;
matching the decrypted number string with both Secret Number and Missing Link Key portions of the corresponding number string stored in the vault; and,
issuing an authorization command to the Authorization Requesting Protocol responsive to a match.

2. The method of claim 1, wherein no randomly generated number string once used to authorize a transaction can be used again.

3. The method of claim 1, wherein the module transmits a user name and password to the vault to initiate the authorization procedure.

4. The method of claim 3, and further including the step of matching the user name and password with a previously stored user name and password at the vault and transmitting a signal to the module to activate the module responsive to a user name and password match.

5. The method of claim 4, and further including the step of the module, after activation, providing a signal to the Authorization Requesting Protocol to activate the Authorization Requesting Protocol.

6. The method of claim 5, and further including the step of activating the vault to permit transmitting the Missing Link Key portion of the associated randomly generated number string upon activation of the Authorization Requesting Protocol.

7. The method of claim 6, and further including the step of transmitting the Missing Link Key from the vault to the Authorization Requesting Protocol responsive to the activation signal from the activated Authorization Requesting Protocol.

8. The method of claim 1, and further including the step of assuring that the module, vault and Authorization Requesting Protocol are properly connected prior to the transmission of the Missing Link Key and the Secret Number to the Authorization Requesting Protocol.

9. A method for establishing Internet security for an authorization process, comprising the steps of:
generating a number of random number strings in sequence at a module, each number string having a Secret Number portion and a Missing Link Key portion;
installing the number strings in an offline vault;
accessing the vault to transmit the Missing Link Key portion of a predetermined randomly generated number string to an Authorization Requesting Protocol at a first time, the Missing Link Key portion being automatically generated and instantly removed after generation so as not to be visible on the Internet for more than a very small period of time not readily detectable by one viewing the Internet;
causing the module to transmit a Secret Number portion of the randomly generated number string to the Authorization Requesting Protocol at a second time;
causing the Authorization Requesting Protocol to transmit to the vault the received Secret Number portion and the received Missing Link Key portion of the randomly generated number string;
matching the transmitted Secret Number portion and Missing Link Key portion to the associated Secret Number portion and Missing Link Key portion stored in the vault; and,
issuing an authorization command upon a match.

10. The method of claim 9, wherein the Secret Number portion and Missing Link Key portion transmitted from the Authorization Requesting Protocol to the vault is encrypted.

11. The method of claim 9, and further including the step of ascertaining that the module, Authorization Requesting Protocol and vault are correctly interconnected.

12. The method of claim 11, wherein the step of ascertaining correct interconnection includes the step of identifying the module at the vault, and responsive to an identity check activating the module to activate the Authorization Requesting Protocol to activate the vault to transmit the Missing Link Key to the Authorization Requesting Protocol.

13. The method of claim 12, wherein the module transmits a user name and password to the vault to identify the module, the module having previously been identified by a user name and password stored in the vault.

14. The method of claim 9, wherein the randomly generated number strings, including Secret Numbers and Missing Link Keys, are uploaded to the vault from a module physically present at the vault.

15. The method of claim 9, wherein once a Missing Link Key is used it is never re-used.

16. The method of claim 9, wherein once a Secret Number is used it is never re-used.

17. The method of claim 9, wherein the randomly generated number string, including Secret Numbers and Missing Link Keys, are installed in the vault by the physical presence of the module at the vault and wherein, after installation, all Missing Link Key portions of the randomly generated number strings are deleted from the module, thus affording increased security.

18. The method of claim 9, wherein the randomly generated number strings, having associated Secret Number portions and Missing Link Key portions, are stored in groups in the vault, and further including the steps of specifying from the module a particular group in which, for an authorization, the randomly generated number string is located and matching the group number at the vault prior to the vault issuing the authorization signal.

19. Apparatus for establishing a secure Internet authorization, comprising:
a module having a random number generator for generating a large number of randomly generated number strings, each of said strings having a Secret Number portion and a Missing Link Key portion;
a vault for storing said randomly generated number strings upon physically uploading of said randomly generated number strings from said module;
an Authorization Requesting Protocol for ascertaining the coincidence of a Missing Link Key portion and a Secret Number portion, the Secret Number portion coming from said module, and the Missing Link Key portion coming from said vault;
means for transmitting the Secret Number portion and Missing Link Key portion to the vault for matching of the associated Secret Number portion and Missing Link Key portion; and,
an authorization signal transmitted from the vault upon said match.

20. The apparatus of claim 19, wherein said vault generates said Missing Link Key portion for transmission to said Authorization Requesting Protocol and automatically deletes the Missing Link Key portion from being transmitted over the Internet after creation.

21. A method for securely establishing authorization over the Internet, comprising the step of:
authorizing an action based on a randomly generated number string generated by a module carried by an individual seeking authorization for the action.

22. The method of claim 21, wherein the action is authorized upon match of the randomly generated number string with a previously stored version of the number string.

23. The method of claim 22, wherein the storage of a randomly generated number string requires the physical presence of a random number generator at an offline vault for the storage of the number string.

24. The method of claim 21, wherein each number string includes a Secret Number portion and a Missing Link Key portion and wherein the Missing Link Key portion is deleted immediately after creation, whereby it does not exist on the Internet for a time that permits ready viewing.

25. The method of claim 24, wherein the matching requires both the Secret Number portion and the Missing Link Key portion be available, both portions generated from a secure source that encrypts the number string, based on the arrival at the source of the Missing Link Key portion and the Secret Number portion at different times, thus to prevent simultaneous viewing of both portions on the Internet in an unencrypted form.
